(19) United States
(12) Patent Application Publication
(10) Pub. No.: US 2024/0394538 A1
(43) Pub. Date: Nov. 28, 2024

(54) GRAPH-LEARNING NEURAL NETWORKS USING SPECTRAL DATA FOR DETECTION OF DEFECTS IN ADDITIVE MANUFACTURING

(71) Applicant: The Boeing Company, Arlington, VA (US)

(72) Inventors: Qin Jiang, Oak Park, CA (US); Eric Clough, Santa Monica, CA (US); Navid Naderializadeh, Philadelphia, PA (US); Heiko Hoffmann, Simi Valley, CA (US)

(21) Appl. No.: 18/324,878

(22) Filed: May 26, 2023

(51) Int. Cl. G06N 3/084; G06T 7/00

(52) U.S. Cl. CPC G06N 3/084; G06T 7/0006; G06T 2207/10116

(57) ABSTRACT

Examples for detection of defects in an additively manufactured object are provided. In one aspect, a method is provided. The method comprises receiving in-situ spectral data measured from the additively manufactured object during an additive manufacturing process, constructing a graph data structure using the in-situ spectral data, and outputting a predicted defect region using the graph data structure and a trained graph-learning neural network.

### FIELD

The field of invention relates generally to defect detection in additive manufacturing processes, and more specifically, defect detection in additive manufacturing processes using spectral data.

### BACKGROUND

Additive manufacturing (AM), also known as three-dimensional (3D) printing, refers to technologies for fabricating, also referred to as printing, three-dimensional objects by forming and bonding successive layers. Various types of AM processes exist. One common class of AM processes includes the fabrication of polymer objects. In polymer AM processes, polymers are extruded or jetted onto a printing platform and subsequently cured to form a layer. Depending on the materials used, different curing processes can be applied. Example curing processes include thermal-curing, photo-curing, and the use of adhesives.

Another class of AM processes includes metal printing for the fabrication of objects using various types of metals and alloys. One example includes powder bed fusion processes. In powder bed fusion, a layer of metallic material, typically in the form of metallic powder, is deposited onto a printing platform. Electron beams, lasers, or other thermal sources are used to selectively melt or sinter a desired pattern from the deposited layer of material. The process is repeated to build successive layers until the final object is formed. Examples of such processes include direct metal laser melting (DMLM), direct metal laser sintering (DMLS), electron beam melting (EBM), selective laser sintering (SLS), and selective heat sintering (SHS).

### SUMMARY

Examples for detection of defects in an additively manufactured object are provided. In one aspect, a method is provided. The method comprises receiving in-situ spectral data measured from the additively manufactured object during an additive manufacturing process, constructing a graph data structure using the in-situ spectral data, and outputting a predicted defect region using the graph data structure and a trained graph-learning neural network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a system diagram of an example additive manufacturing system with in-situ nondestructive inspection for defect detection.

FIG. 2 shows a system diagram of an example defect detection system implementing a trained graph-learning neural network model for predicting defect regions in an additive manufacturing process, which can be utilized in additive manufacturing system of FIG. 1.

FIG. 3 shows an example graph data generated from spectral data, which can be utilized in the graph-learning neural network model described in FIG. 2.

FIG. 4 shows an example system diagram of a graph-learning neural network, which can be implemented in the defect detection system of FIG. 2.

FIG. 5 shows a flow chart of an example data resampling method, which can be implemented in the training process described in FIG. 2.

FIG. 6 shows a table with experimental results of an example defect detection system implementing a graph-learning neural network, such as the defect detection system of FIG. 2.

FIG. 7 shows a graph of example solid spectral values and void spectral values associated with the experimental results shown in FIG. 6.

FIGS. 8A and 8B show training loss curves for two data set variations, respectively, for the example graph-learning neural network used to produce the experimental results shown in FIG. 6.

FIGS. 9A and 9B show ROC curves for the void class for two data set variations, respectively, in the testing phase of the example graph-learning neural network used to produce the experimental results shown in FIG. 6.

FIG. 10 shows a flow chart of an example method for detecting defects in an additively manufactured object, which can be implemented using the system described in FIG. 1.

FIG. 11 schematically shows an embodiment of a computing system that can enact one or more of the methods and processes described above.

### DETAILED DESCRIPTION

Additive manufacturing provides many advantages, such as the ability to fabricate parts with complex geometries, quick prototyping, customization of materials, flexibility in design, and minimal material waste. However, during an AM fabrication process, defects can be formed in the printed layers for a variety reasons, which can lead to insufficient material properties in the printed objects. As such, some AM applications implement a system for monitoring defect formation during the fabrication process to achieve consistent quality across the printed objects.

Various types of quality assurance monitoring processes can be implemented. Nondestructive inspection (NDI) techniques are generally advantageous due to their ability to monitor defect formation in AM without ex-post destructive measurements of the fabricated parts. One such NDI technique includes the use of cameras to monitor the fabrication process. Although such imaging techniques can detect various types of defects in many applications, they can be non-ideal for some use cases. For example, although cameras and their image data are well-suited for detecting surface defects, they lack the ability to adequately detect internal issues, such as areas of low density, strength, etc., which are often issues in many AM applications, including AM processes for fabricating metal objects.

In view of the observations above, examples of graph-learning neural networks using spectral data for the detection of defects in AM processes are provided. The use of spectral data for the detection of defects can be implemented as an NDI technique for various applications, including a broad range of AM applications. Examples of such applications include polymer and metal fabrication across various industries, such as aerospace and automotive, that make use of AM processes. Such NDI techniques can be applicable to additively manufactured components with complex internal features that are otherwise challenging to inspect via traditional nondestructive means (e.g., ultrasound, camera imaging). For example, NDI techniques utilizing spectral data enable monitoring of fabricated parts for low density regions, which can be defects that are difficult to detect using traditional camera imaging monitoring systems.

Spectral response measurements (e.g., visible, infrared, and other bands of the electromagnetic spectrum) can be performed during the AM process to monitor for defects in the object being fabricated. In some implementations, spectral data is measured in-situ. In further implementations, spectral data is measured every time a layer is printed. In comparison with other techniques, such as vision-based and ultrasonic testing-based techniques, spectral data contains more information regarding defect characteristics. Additionally, spectral data measurements can be performed at a higher resolution (e.g., <100 micrometers spectral point spacing).

In some implementations, in-situ spectral data is used in combination with machine learning techniques to provide a nondestructive in-line defect detection system. Such implementations can be applied for various AM processes, including the fabrication of metal and metal alloy parts. Various types of machine learning techniques can be utilized. One model includes the use of a deep learning neural network to predict defect regions in the part being fabricated during the AM process. In some implementations, the neural network is a graph-learning neural network. For example, geo-positions of spectral data can be used to construct a graph that can be utilized with a graph-learning neural network model to classify defect regions in the object being fabricated.

In addition to spectral information, the spectral data can include spatial information that corresponds to geo-positions where the measurements were taken. When measurement noise or variations in the process conditions are present in the fabrication process, defect detection becomes more difficult as defect regions may have different in-situ spectral measurements. Spatial information from in-situ spectral data of the defect regions and their spatial neighborhoods can be used to improve defect detection, including in the presence of measurement noise. In some implementations, graph data structures are used to represent the spatial information and the spatial relationship of printed objects. Such graph data structures can be used in combination with a graph-learning neural network to identify defect points/regions.

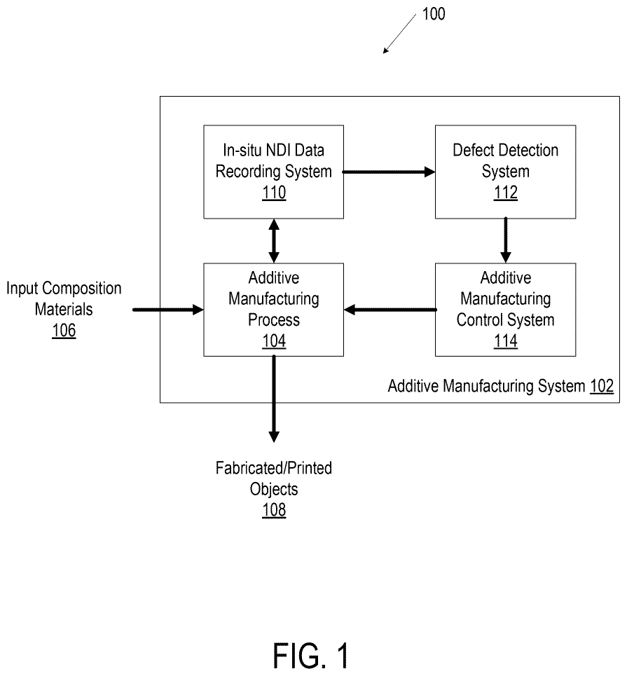

FIG. 1 shows a system diagram 100 of an example AM system 102 with in-situ NDI for defect detection. The AM system 102 is configured to implement an AM process 104, which successively prints layers of an input composition material 106 to fabricate an object 108. Various types of AM processes can be implemented, including processes for the fabrication of metal and metal alloy parts. Examples of such processes include DMLM, DMLS, EBM, SLS, and SHS.

The AM system 102 includes an in-situ NDI data recording system 110 for illuminating and reading spectral data radiating from the object 108 being printed. The NDI data recording system 110 can include various equipment for performing spectral data measurements, such as a spectrometer. Spectral data can be read for each printed layer. In some implementations, the spectral data is recorded as in-situ spectral data measured at two or more geo-positions on the printed layer.

The AM system 102 further includes a defect detection system 112 that can analyze the spectral and spatial information from spectral data received from the in-situ NDI data recording system 110. From the input data, the defect detection system 112 can identify or predict defect regions in the object 108 being printed. In-situ spectral data measurements enable prediction of such defect regions during the AM fabrication process 104 while the object 108 is being fabricated. Depending on how the spatial and spectral information is recorded and represented, different methods for the identification or prediction of defect regions can be implemented. For example, the spatial information can be represented by a graph containing nodes and edges, and the spectral information can be represented as variables defined on the nodes of the graph. In some implementations, the graph is a local graph. Representation of the spectral data as a graph can be utilized in different defect detection methods. In some implementations, a graph-learning neural network is utilized to identify defect regions using the graph representing the spectral data.

The AM system 102 further includes an AM control system 114, which receives input from the defect detection system 112. The input data can include information describing identified or predicted defect regions. The AM control system 114 uses the received information to manage variables that control the AM fabrication process 104. In some implementations, the variables are adjusted during the fabrication process. For example, the AM control system 114 can be configured to halt the AM fabrication process 104, if necessary, and adjust the variables accordingly when a defect is detected by the defect detection system. The AM fabrication process 104 can be adjusted to correct for and/or to prevent defects based on the received input data from the defect detection system 112. Different AM fabrication processes can include different variables that affect the printing process. For example, a polymer AM fabrication process can involve variables such as nozzle speed, nozzle temperature, curing speed, etc. Metal AM fabrication processes can involve variables such as laser wattage, ambient temperature, ambient humidity, etc.

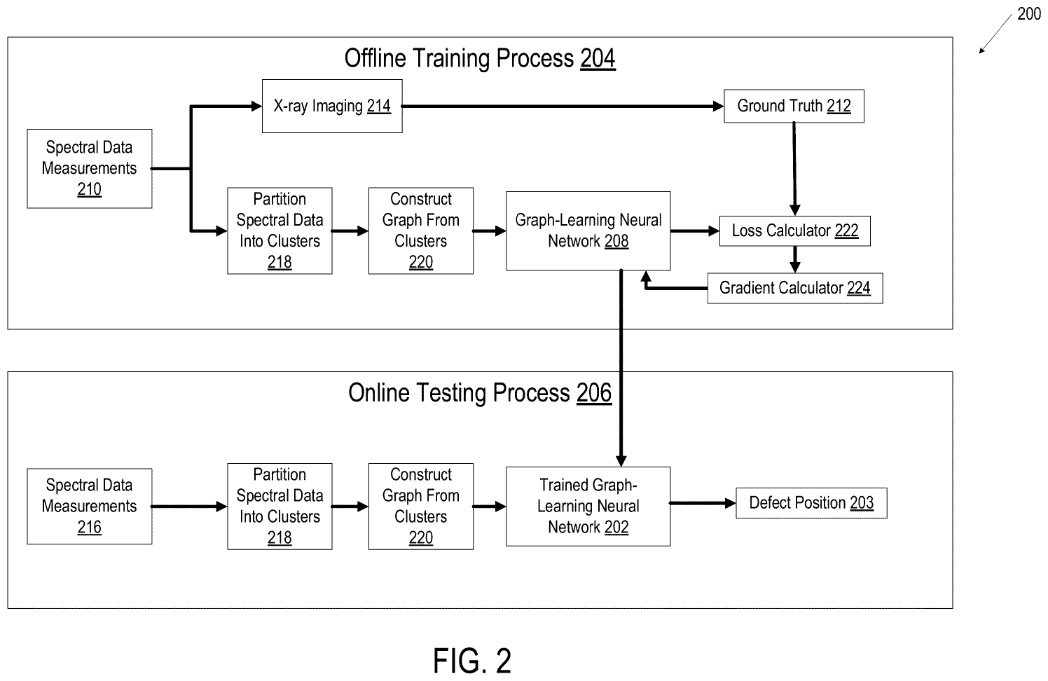

FIG. 2 shows a system diagram 200 of an example defect detection system implementing a trained graph-learning neural network model 202 for predicting defect regions 203 in an AM process. In some implementations, graphs are implemented to represent spatial information with spectral information being treated as variables defined on the nodes of the graph. Graph-learning neural networks can be used to take advantage of the spatial correlation of defect regions to enhance the defect detection in AM process. For example, regions in spatial proximity to defect regions are more likely to also contain defects.

In the depicted example, the defect detection system includes two processes, an offline training process 204 and an online testing process 206. In the offline training process 204, a graph-learning neural network 208 is implemented and trained to identify defect regions in the fabrication process of an AM machine. During training, spectral data 210 taken during an AM process and accompanying labeled data 212 (ground truth) are used to train the graph-learning neural network 208. Labeled data 212 can be provided through various ways. In some implementations, labeled data 212 is provided by finding defects in the object from which the spectral data 210 was taken during the AM process. Defects can be found using various techniques, including the use of x-ray imaging 214. For example, a computerized tomography (CT) imaging equipment can be used to provide a CT scan of a printed object, which can show defect regions in the printed object to provide ground truth labeled data for the training process 204.

The training spectral data set 210 and accompanying labeled data set 212 can be converted into graphs for use with the graph-learning neural network 208. Similarly, during the online inference process, in-situ spectral data 216 recorded during an AM process can also be converted into a graph representation. The graph can then be used as input to the trained graph-learning neural network 202 to predict defect regions 203 in the input data. The conversion of spectral data 210 into a graph representation can be performed using various methodologies. In the depicted example, the data sets are partitioned 218 into local clusters based on the geo-position information (spectral measurement position in the printed layer) of the spectral data. Local clusters can be used to construct 220 one or more graphs with their local connections, and the one or more graphs can be used to train the graph-learning neural network. Such methods can also be performed to convert the in-situ spectral data 216 recorded during an AM process into one or more graphs for use with the trained graph-learning neural network 202 during the online testing process 206. It is noted that a graph can be a disconnected graph such that it comprises a plurality of graphs that are not connected to one another. As such, constructing a plurality of graphs from the local clusters can be equivalent to constructing a single graph from the local clusters. For ease of description, graphs that make up a single graph may also be referred to as sub-graphs.

The training process for the graph-learning neural network 208 can include loops of training that iteratively adjust parameters in the graph-learning neural network 208 in an attempt at generating a trained graph-learning neural network that performs its given task with higher accuracy. In the depicted example, the training loop includes outputting one or more predicted defect regions using the graph constructed from the training spectral data 210. The predicted defect regions are compared with the labeled data set 212 using a loss calculator 222, which computes a loss value based on a loss function. Various types of loss functions can be utilized, such as L1 or L2 loss functions. The computed loss value represents the accuracy of the graph-learning neural network 208 in its task of predicting defect regions. Based on the computed loss value, a gradient calculator 224 calculates a gradient that can be used to adjust the graph-learning neural network 208. The training loop then repeats iteratively for a predetermined number of iterations (i.e., number of epochs) or until the output converges to within a predetermined threshold.

Graph data can be represented by three components: node, edge, and value on nodes. Mathematically, a graph can be represented by G={node,edge,value}. The node contains the node-index in the graph; the edge are the connections between the nodes; and the value are the variables defined on nodes. The “value” of a node can include spectral data, which can further include one or more spectral values. Each sub-graph constructed from a local cluster captures the local spatial correlations in the input data. Various methods can be used to construct the sub-graphs. A k-means clustering algorithm can be used to partition the spectral data into local clusters/groups based on the positions of the spectral data. In some implementations, the spectral data is partitioned into a set of clusters C by minimizing the sum of the variances of the clusters. For example, for a given set of data points containing geo-positions P={p₁, p₂, . . . , p_{N}} and k clusters, the set of clusters C={c₁, c₂, . . . , cₖ} can be estimated by the following equation:

$$arg {min}_{c} {\sum }_{i = 1}^{k} {\sum }_{p ∈ {c}_{i}} {‖ p - {m}_{i} ‖}^{2} \qquad ( 1 )$$

where the variable mᵢ is the center of the i^{th} cluster computed by:

$${m}_{i} = \frac{1}{\vert {c}_{i} \vert} {\sum }_{{p}_{j} ∈ {c}_{i}} {p}_{j} . \qquad ( 2 )$$

The number of clusters k can be predetermined. In some implementations, the number of clusters k is much less than the number of data points N—i.e., (k<<N). Since spectral data may not be measured at uniformly distributed positions, the k-means clustering algorithm can be used to find the clusters of points with locally close positions. Numerically, the k-means clustering algorithm can be implemented by a method of iteratively data-partitioning the spectral data. The method can include first randomly initializing k cluster centers. Each data point can be assigned to the cluster that has the minimal distance between said data point and the cluster's center. With the newly assigned data points, the center of each cluster is re-calculated. The steps of assigning data points and re-calculating the cluster centers can be iteratively repeated until the values of the cluster centers converge or until a predetermined number of iterations is reached, and the set of clusters C can be output.

After the data-partitioning process, input spectral data become k-cluster data represented by C={c₁, c₂, . . . , cₖ} and cᵢ={node,value}, where the node represents the points in the cluster and the value represents the spectral values on the points/nodes. To convert the cluster data into graph data, edge-connections are determined. Various methods can be used to determine the edge-connections. In some implementations, a K-nearest-neighbor graph method is implemented to convert the cluster data into graph data. Each point of a cluster can be treated as a graph node, and the local spatial relationships of graph nodes are used to construct the edge-connections for said cluster. In a K-nearest-neighbor graph method, which is a method that is independent and distinct from the k-means clustering algorithm discussed elsewhere herein, K nearest nodes are selected to make undirected edge connections for a given graph node. For example, with K=4, each graph node is connected to the closest four nodes in the graph. Mathematically, for a given set of nodes/points S={p₁, p₂, . . . p_{M}}, the edge-connections of the i^{th} point/node are calculated by:

$${E}_{i} = \{ {e}_{ij} : {p}_{i} ↔ {p}^{( j )} and {p}^{( j )} ∈ {S}_{i} \} . \qquad ( 3 )$$

The set variable, Sᵢ, is the local-neighbor-set for the i^{th} node in the graph. Each node is connected to the nodes in its local-neighbor-set, which is calculated by:

$${S}_{i} = \{ {p}^{( j )} : ‖ {p}^{( 1 )} - {p}_{i} ‖ < ‖ {p}^{( 2 )} - {p}_{i} ‖ < … < ‖ {p}^{( K )} - {p}_{i} ‖ , and {p}^{( j )} ∈ S \} . \qquad ( 4 )$$

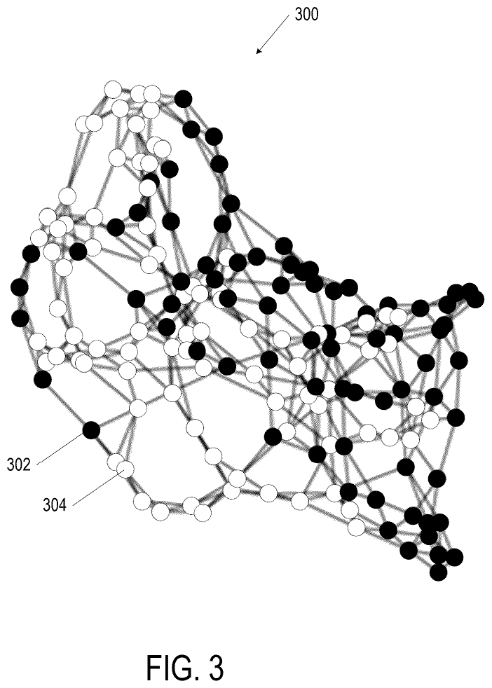

FIG. 3 shows an example graph data 300 generated from spectral data. The graph data 300 represents an example sub-graph constructed from a cluster after edge-connections are determined. From the spectral data, nodes can be classified to be solid, indicating potentially good nodes, or void, indicating potentially defect nodes. In the depicted example graph, solid nodes are indicated as black nodes (e.g., node 302), and void nodes are indicated as white nodes (e.g., node 304). The edge-connections in the graph data 300 represent spatial relationships of graph nodes. Using this information, defect nodes can be identified more accurately. For example, if a node has connections to only defect nodes, there is a high probability that said node is a defect node. When used in combination with a graph-learning neural network, graph node classification can be further enhanced.

Many different types of neural network models can be used to predict defect regions. Certain models can be advantageous over other models depending on the application. In AM processes, defect regions can be correlated to spectral data from the printed object, including the spatial information of the spectral data. Some traditional neural network models, however, are unable to utilize spatial information of such data. For example, traditional convolution neural networks (CNN) have been successfully applied to many classification applications, such as image classification, semantic segmentation, and speech recognition. When applied to the detection of defect regions in AM processes, however, CNN networks are unable to make use of the geometric information of the defect regions due to, among other reasons, the detection positions (geometric positions of NDI measurements) being non-uniformly distributed.

In some implementations, a graph-learning neural network capable of exploiting the spatial information from the spectral data is utilized. The use of geometric and spatial information can be helpful for identifying defect regions, including in AM processes with noisy environments. Example sources of noise include measurement noise and the condition variations of the fabrication process. In a graph-learning neural network, the spatial relationship/information of input data can be represented by edge-connections in the input graph. These edge-connections provide more information for model-learning compared to CNN networks. As a result, graph-learning neural networks are able to provide better classification results than CNN networks when the input data can be represented by graph data.

The representation of a graph can include two sets, nodes and edges. The node set V contains the indexes of graph nodes, and the edge set E contains the edges connecting the graph nodes. A graph learning neural network layer learns node representation by aggregating its neighbor's representation. Node representation is a function defined on graph nodes. A graph network layer includes a set of input nodes and a set of output nodes. Let input node be represented by {hᵢⁱⁿ∈R^{d}^{ᵢₙ}:i∈V} and the output nodes be represented by {hᵢ^{out}=R^{d}^{ₒᵤₜ}:i∈V}. The functional representations of output nodes can be calculated by:

hᵢ^{out}=ƒ_{θ}(hᵢⁱⁿ,g({hⱼⁱⁿ:j∈Nᵢ})) (5)

where the function, ƒ_{θ}(x) is an activation function; the function g(x) is an aggregating function; and the neighborhood set Nᵢ is given by:

Nᵢ={j∈V:(i,j)∈E} (6).

The neighborhood set Nᵢ contains the indexes of the nodes that have an edge connection to the i^{th} node. Neighboring nodes can have equal importance for the learning at the i^{th} node. This can limit the learning capability of a graph neural network since if the i^{th} node is a defect node, a defect neighboring node should have a larger contribution than a normal neighboring node. To overcome this issue, an attention model can be used to compute weights that control the contributions from different neighboring nodes. For every edge, an edge score can be calculated by:

eᵢⱼ(hᵢ,hⱼ)=a^{T}ƒₑ(W*[hᵢ,hⱼ]) (7)

where the function ƒₑ(x) is an activation function; the vector a and the matrix W are learned from a linear network called attention layer. Normalizing the edge scores produces the edge weights given by:

$${a}_{ij} = softmax ( {e}_{ij} ) = \frac{exp ( {e}_{ij} )}{{\sum }_{K ∈ {N}_{i}} exp ( {e}_{iK} )} . \qquad ( 8 )$$

The output representation can be calculated by:

$${h}_{i}^{out} = {f}_{σ} ( {\sum }_{j ∈ {N}_{i}} {a}_{ij} * {Wh}_{j}^{i n} ) . \qquad ( 9 )$$

where the function ƒ_{σ}(x) is an activation function. As shown, for the learning at the i^{th} node, different neighboring nodes have different contributions controlled by the weight values.

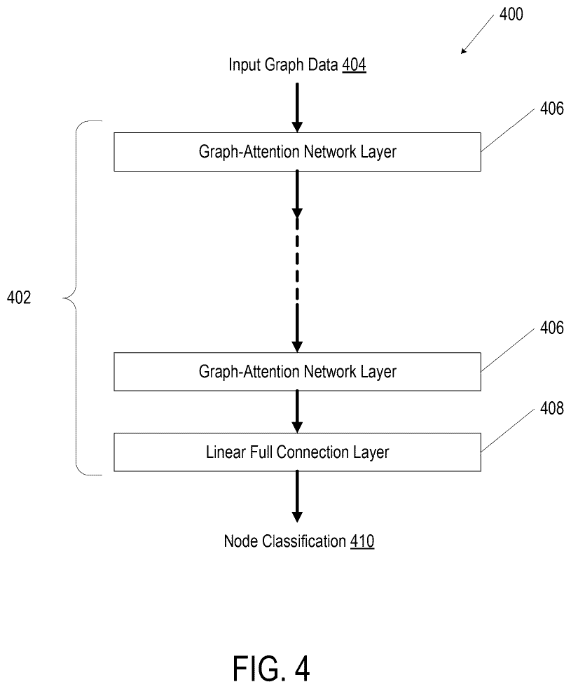

FIG. 4 shows an example system diagram 400 of a graph-learning neural network 402. The graph-learning neural network 402 can be configured to learn differences between normal nodes (solid nodes) and defect nodes (void nodes) from input graph data 404. In the depicted example, the graph-learning neural network 402 includes a number of graph-attention layers 406 and one linear full-connection layer 408. As can readily be appreciated, any number of graph-attention layers 406 can be used. In some implementations, the graph-learning neural network 402 includes six graph-attention layers 406. The graph-attention layers 406 can be configured to contain different numbers of neurons. The linear full-connection layer 408 is used as the output layer, which is configured to map the graph-attention layers 406 to the two classes of the output to perform node classification 410. The linear full-connection output can be computed by:

$${y}_{i} = {f}_{σ} ( {W}_{f} {h}_{i}^{i n} + b ) . \qquad ( 10 )$$

Various activation functions can be utilized in the graph-learning neural network. In some implementations, leaky rectified linear unit (ReLU) is used as the activation function. In the graph-attention layers, ReLU function can be used as the activation function. In the final layer, log-softmax function can be used as the activation function. The ReLU function can be defined by:

$$y = ReLU ( x ) = max ( 0 \text{.0} , x ) . \qquad ( 11 )$$

The log-softmax function can be defined by:

$${y}_{i} = log softmax ( {x}_{i} ) = log ( \frac{exp ( {x}_{i} )}{{\sum }_{j} exp ( {x}_{i} )} ) . \qquad ( 12 )$$

In an AM process, printed materials/objects typically have very few, if any, defect regions. As such, training data will likely have an overrepresentation (for the purposes of neural network learning) of normal data samples over defect data samples. This causes a data-imbalance problem in the neural network training process, which can result in an over-fitting problem that produces a trained neural network with lower accuracy. Various techniques can be implemented to address the data-imbalance problem. In some implementations, data-resampling is performed to reduce the imbalance in training data sets. For example, a down-sampling method can be implemented to reduce the data-imbalance in the training data. Use of a random-sampling method may destroy the spatial information used for constructing the graph data. As such, other approaches may be advantageous used over such random-sampling methods. In some implementations, a sequential down-sampling approach is used to reduce the number of normal data samples to reduce the data-imbalance problem.

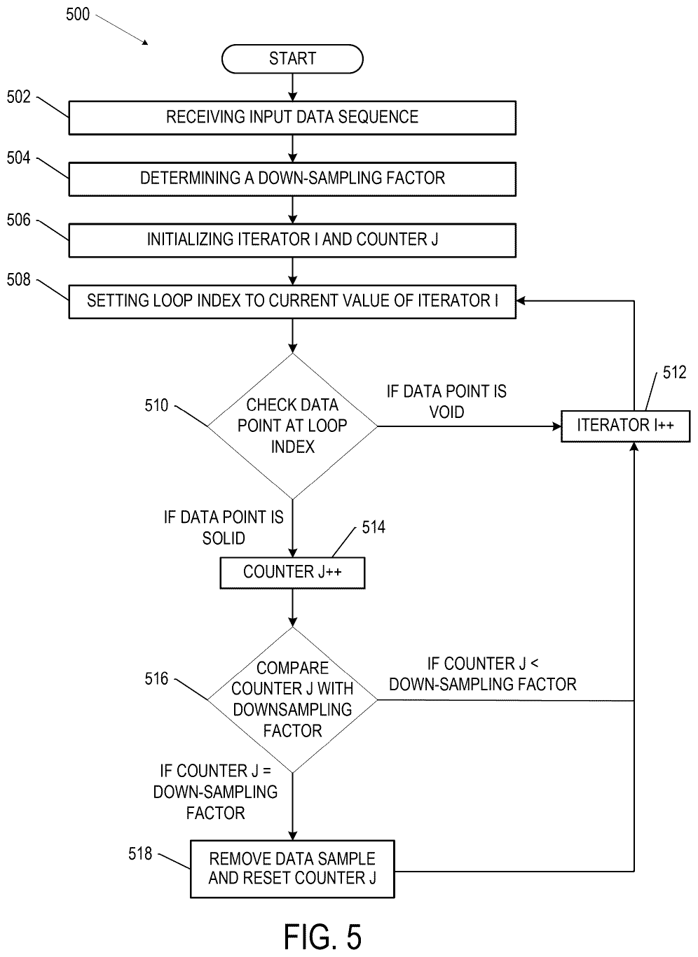

FIG. 5 shows a flow chart of an example data down-sampling method 500. The method 500 describes a sequential process for removing solid data points. At step 502, the method 500 includes receiving an input data sequence. The input data sequence can include spectral data points recorded by an in-situ NDI data recording system utilizing spectroscopy. For example, the input data sequence can be received in real-time as spectral data is measured during an AM process. The down-sampling process can be performed concurrently as the input data sequence is received in real-time.

At step 504, the method 500 includes determining a down-sampling factor for removing solid data points. Any down-sampling factor can be used. In the depicted example of method 500 of FIG. 5, a down-sampling factor of eight indicates that out of eight solid data points, one is removed. The down-sampling factor can be dependent on the type of AM process implement and/or material used in the fabrication process. For example, certain types of AM processes and/or fabrication materials used can have higher defect rates. In such cases, the down-sampling factor of solid data points may be lower.

At step 506, the method 500 includes initializing an iterator i for indexing the received data sequence and a counter j for determining when to remove a solid data point. Iterator i can be initialized to the first data point position in the received data sequence. The value of the initialized counter j can depend on the logical algorithm implemented. For example, the counter j can be initialized to zero or one depending on the algorithm. In the depicted example method 500 of FIG. 5, the counter j is initialized to zero.

At step 508, the method 500 includes setting a loop index to the current value of iterator i. During each loop iteration, the iterator i is incremented to the index of the next data point in the received data sequence.

At step 510, the method 500 includes checking the data point of the current loop index to determine whether the data point is a solid data point or a void data point. Such determination can be made based on the spectral data. If the data point is a void data point, the iterator value is incremented (i=i+1) at step 512, and the next iteration of the loop is performed, starting at step 508. If the data point is a solid data point, the counter j is incremented at step 514, and the process continues at step 516.

At step 516, the method 500 includes comparing the counter j to the down-sampling factor to see if a predetermined threshold is met. If the predetermined threshold is not met, the data point at the current loop index remains in the data set. If the predetermined threshold is met, the data point at the current loop index is removed from the data set and counter j is reset at step 518. In the depicted example, the predetermined threshold is met if the value of the counter j is equal to the down-sampling factor. Along with the initialization of counter j at the value of zero, these sets of conditions implement an algorithm that reduces the data set to approximately (s−1)/s given a down-sampling factor of s. As can readily be appreciated, other threshold conditions and initializations schemes can be used to implement a down-sampling method. For example, the down-sampling method can be configured to remove two out of every three solid data samples. Whether step 518 is performed or not, the iterator i is incremented 512, and the loop then starts again at step 508.

The iterations of steps 508 and 518 can continue until all data points in the received data sequence are checked. In some implementations, the data down-sampling method 500 is performed as an online process in parallel with a defect detection process implemented to monitor an AM process in real-time. In such cases, data points can be received in sequence as they are recorded by an in-situ NDI data recording system. For example, batches of data points can be received when the in-situ NDI data recording system performs spectral measurements after each printed layer in the AM process.

Another method addressing the over-fitting problem includes the use of a drop-out layer in the graph-learning neural network. For example, in the neural network configuration depicted in FIG. 4, a drop-out layer can be implemented before the final layer—the full-connection layer. In a training process, a drop-out layer drops out the gradient-back-propagation to the next layer by a predefined percentage, which effectively reduces the fitting capability of the learning neural network. Such configurations can be implemented during the training process since the drop-out layer does not provide any function for the classification capability of the graph-learning neural network.

Another issue in training a graph-learning neural network includes data normalization. Since the components of in-situ NDI spectral data may not be distributed in the same dynamic range; larger components may dominate the learning process. To make every component provide the same contribution to the learning process, the spectral data can be normalized such that each component of the spectral data has zero mean and unit variance. Mathematically, let x(t) be one component of spectral data. Normalized xₙₘ(t) can be calculated by:

$${x}_{n m} ( t ) = \frac{( x ( t ) - {m}_{x} )}{{σ}_{x}} \qquad ( 13 )$$

where the variable mₓ is the mean of the component and the variable σₓ is the standard division of the component. After normalization, the components of the spectral data are distributed in overlapped ranges around zero.

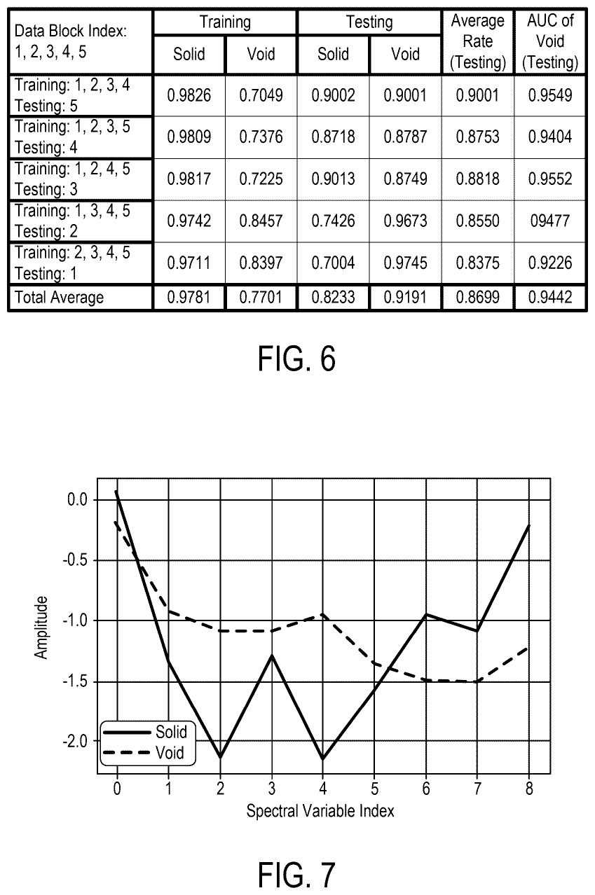

FIG. 6 shows a table with experimental results of an example defect detection system implementing a graph-learning neural network. The results show classification rates of five data sets of in-situ NDI spectral data of Ti-64 alloy materials. The raw data includes measurement times, measurement positions (x, y, z), nine spectral values (laser4, plasma4, melt4, plasma3, melt3, plasma2, melt2, plasma1, melt1), and classifications (solid, void). The five data sets include 3,647,572 solid data samples and 75,779 void data samples that are almost uniformly divided among the five data sets. The data sets can be considered to be imbalanced as the number of solid samples is forty-eight times of the number of void samples.

Determination of whether a data sample is solid or void can depend on their corresponding spectral data. FIG. 7 shows a graph of example solid spectral values and void spectral values. The solid spectral values are represented by a solid line, and the void spectral values are represented by a dashed line. As shown, the two types exhibit significant differences that can be used to distinguish between the two types for the classification of data points.

For the experimental results shown in FIG. 6, the graph-learning neural network implemented includes 200 nodes in the first layer, 400 nodes in the second layer, 200 nodes in the third layer, 100 nodes in the fourth layer, and 20 nodes in the fifth layer. The final layer maps 20 nodes to two nodes (two classes). As can readily be appreciated, the graph-learning neural network can be configured in many different ways with different numbers of layers and nodes within each layer.

FIG. 6 provides classification results (classification rates) for five different sets of experimental data using different variations of the five block data sets. In each variation, four block data sets were used for training the graph-learning neural network, and the fifth block data set was used for testing the trained neural network. For the training data sets, solid data samples are down-sampled by a factor of eight for reducing the data-imbalance problem. For the testing data set, solid samples are down-sampled by a factor of two for reducing the size of graphs, which reduces computation time.

To convert spectral data into graph data, the number of clusters used in the k-means method in each block data set is determined by the total sample number of the block divided by 100, which means that each graph data contains approximately 100 nodes. Since the number of nodes in each graph is determined by the k-means clustering algorithm, the clusters of a data block may have different numbers of graph nodes. Since the training data set was down-sampled four times more than the testing data set, the number of graphs in the training data and the testing data are similar. For example, when blocks 2, 3, 4, and 5 are used for training and block 1 is used for testing, there are 3,951 graphs in the training graph data and 3,752 graphs in the testing graph data. FIG. 3 depicts one example of the graph data obtained from the training data.

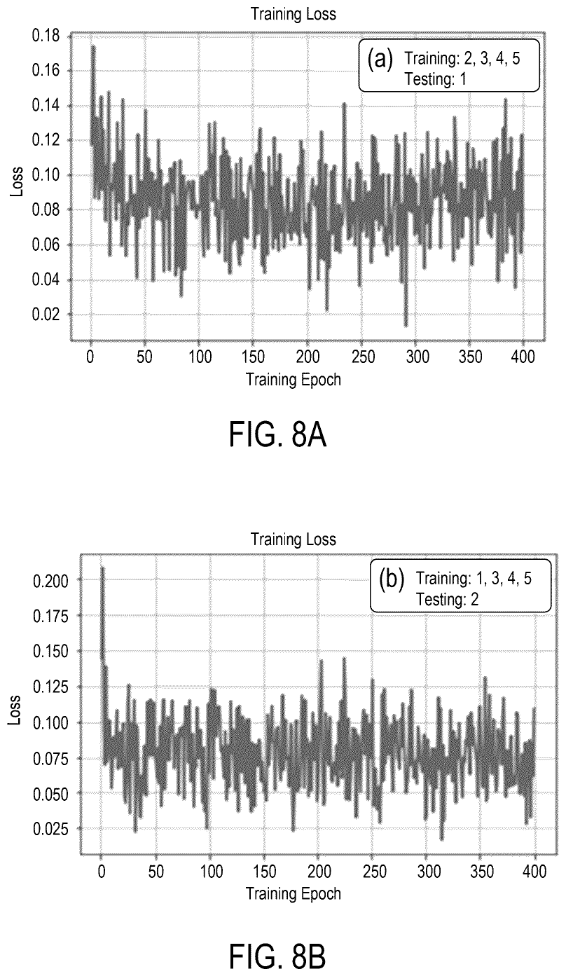

To train the graph learning network, the following parameters were used: batch size=64, learning rate=2.0e-3, the Adam gradient algorithm, and training epoch=400. FIGS. 8A and 8B show training loss curves for two data set variations, respectively, for the example graph-learning neural network used to produce the experimental results shown in FIG. 6. The loss curves show a larger variance than typical due to random shuffling in the drawing of the batch data. This resulted in a larger variance in the loss function, but the training converges faster.

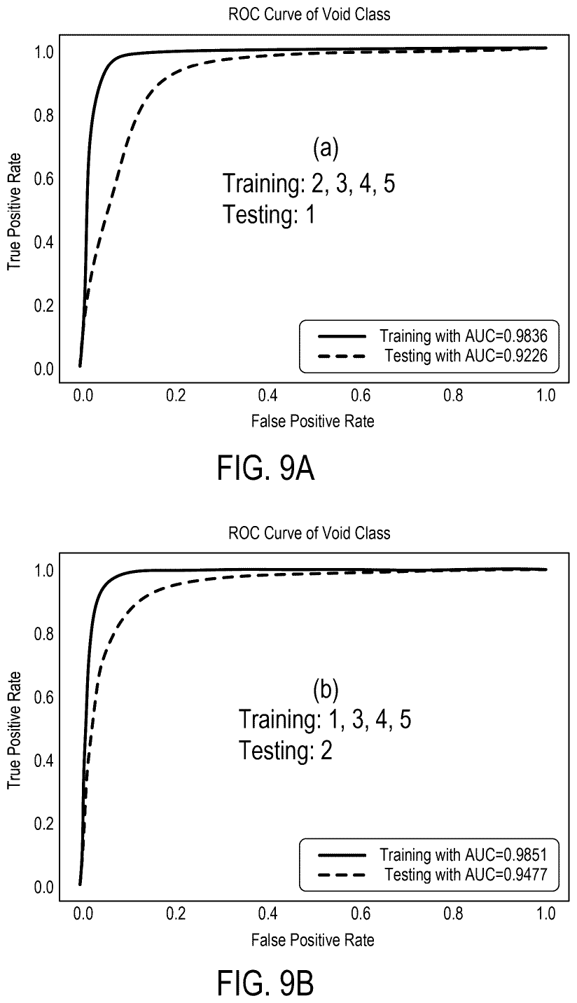

Classification rate and receiver operating characteristic (ROC) curves were used to measure the quality of the defect identification system, where the score of area under curve (AUC) is used to measure the quality of the ROC curve. FIGS. 9A and 9B show ROC curves for the void class for two data set variations, respectively, in the testing phase of the example graph-learning neural network used to produce the experimental results shown in FIG. 6. Dashed lines are the ROC curves of the void class in the testing phase while the solid lines are the ROC curves of the void class in the training phase. The ROC curves in the training phase are close to the ideal curve, indicating that the training process converges well. In the testing phase, the graph-learning neural network produces an average classification rate of 91.91% and an average AUC score of 0.94 for the void nodes (samples). As such, the graph-learning neural network is effective in identifying defect (void) samples from in-situ NDI spectral data for AM processes.

The defect detection system described in the present disclosure provides for the ability to identify and/or predict defect regions during an AM process using in-situ NDI spectral data. The in-situ NDI spectral data can be used to construct a graph data structure for use with a graph-learning neural network for the prediction. Various methodologies can be implemented to perform such predictions.

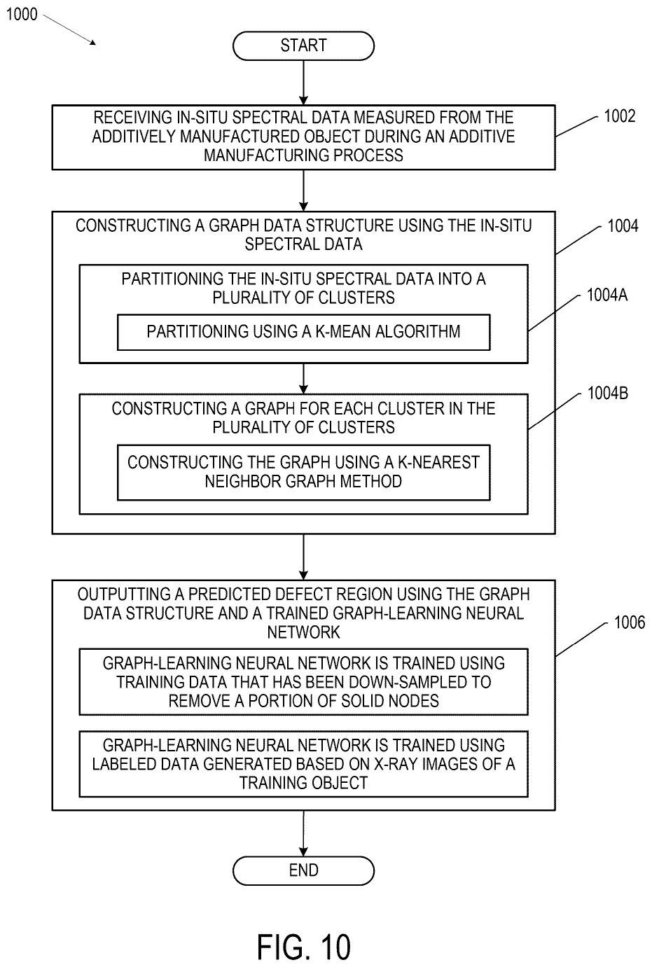

FIG. 10 shows a flow chart of an example method 1000 for detecting defects in an additively manufactured object. At step 1002, the method 1000 includes receiving in-situ spectral data. The in-situ spectral data can be measured from the additively manufactured object during its fabrication process. The spectral data can include spectral measurements and spatial information, such as the geo-positions of the spectral measurements. Various types of spectral measurements can be performed. In some implementations, the in-situ spectral data includes infrared radiation measurements. Any type of equipment for performing such measurements can be used. For example, a spectrometer can be used to perform the spectral data measurements.

At step 1004, the method 1000 includes constructing a graph data structure using the in-situ spectral data. The graph data structure can be constructed using various methods. In some implementations, the in-situ spectral data is partitioned into a plurality of clusters, which can then be used to construct the graph data structure. Partitioning of the in-situ spectral data can be performed using various methods. The number of clusters can be predetermined. Different mathematical algorithms can be implemented. An example of such includes a k-means clustering algorithm where clusters can be determined in an iterative method of data partitioning.

After the in-situ spectral data is partitioned into the plurality of clusters, a graph data structure can be constructed. In some implementations, a graph is constructed for each cluster. The graph construction process can be implemented using a variety of methods. In some implementations, a K-nearest neighbor graph method is used to generate edge-connections for a given cluster to construct the graph.

At step 1006, the method 1000 includes outputting a predicted defect region. In some implementations, a trained graph-learning neural network is used to take the graph data structure as input and output at least one predicted defect region. The trained graph-learning neural network can be configured to analyze the spectral measurements and their spatial information.

The trained graph-learning neural network can be implemented in various ways. In some implementations, the trained graph-learning neural network is trained with an iterative process that uses training data sets that include spectral data of one or more additively-manufactured objects. The training data sets can be converted into graph data structures using any of the methods described in the present disclosure.

A typical additively-manufactured object has many more spectral measurements corresponding to solid nodes compared to measurements that correspond to void nodes. In such cases, there can be a data imbalance problem for the purposes of neural network training. In some implementations, a down-sampling process can be performed to remove a portion of data samples that correspond to solid nodes.

Labeled data sets can be generated by analyzing the one or more additively-manufactured objects for defects. Various methods can be utilized to determine the defects. In some implementations, x-ray imaging is performed on the one or more additively-manufactured objects to find defects, which serve as ground truth for the training process.

In some embodiments, the methods and processes described herein may be tied to a computing system of one or more computing devices. In particular, such methods and processes may be implemented as a computer-application program or service, an application-programming interface (API), a library, and/or other computer-program product.

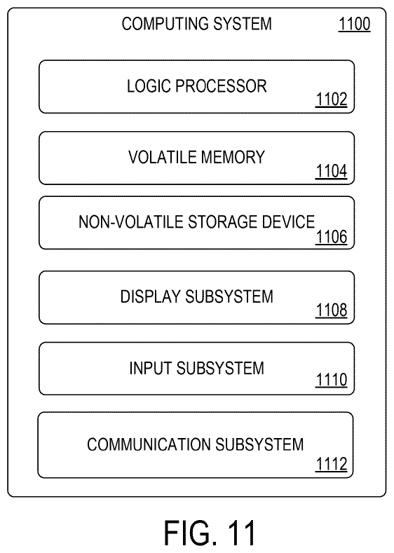

FIG. 11 schematically shows an embodiment of a computing system 1100 that can enact one or more of the methods and processes described above. Computing system 1100 is shown in simplified form. Computing system 1100 may embody a computer device for use in any of the systems described above and illustrated in FIG. 1. Computing system 1100 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 1100 includes a logic processor 1102 volatile memory 1104, and a non-volatile storage device 1106. Computing system 1100 may optionally include a display subsystem 1108, input subsystem 1110, communication subsystem 1112, and/or other components not shown in FIG. 11.

Logic processor 1102 includes one or more physical devices configured to execute instructions. For example, the logic processor 1102 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 1102 may include one or more physical processors (hardware) configured to execute software instructions. Additionally or alternatively, the logic processor 1102 may include one or more hardware logic circuits or firmware devices configured to execute hardware-implemented logic or firmware instructions. Processors of the logic processor 1102 may be single-core or multi-core, and the instructions executed thereon may be configured for sequential, parallel, and/or distributed processing. Individual components of the logic processor 1102 optionally may be distributed among two or more separate devices, which may be remotely located and/or configured for coordinated processing. Aspects of the logic processor 1102 may be virtualized and executed by remotely accessible, networked computing devices configured in a cloud-computing configuration. In such a case, these virtualized aspects are run on different physical logic processors of various different machines, it will be understood.

Non-volatile storage device 1106 includes one or more physical devices configured to hold instructions executable by the logic processors to implement the methods and processes described herein. When such methods and processes are implemented, the state of non-volatile storage device 1106 may be transformed—e.g., to hold different data.

Non-volatile storage device 1106 may include physical devices that are removable and/or built-in. Non-volatile storage device 1106 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1106 may include nonvolatile, dynamic, static, read/write, read-only, sequential-access, location-addressable, file-addressable, and/or content-addressable devices. It will be appreciated that non-volatile storage device 1106 is configured to hold instructions even when power is cut to the non-volatile storage device 1106.

Volatile memory 1104 may include physical devices that include random access memory. Volatile memory 1104 is typically utilized by logic processor 1102 to temporarily store information during processing of software instructions. It will be appreciated that volatile memory 1104 typically does not continue to store instructions when power is cut to the volatile memory 1104.

Aspects of logic processor 1102, volatile memory 1104, and non-volatile storage device 1106 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1100 typically implemented in software by a processor to perform a particular function using portions of volatile memory, which function involves transformative processing that specially configures the processor to perform the function. Thus, a module, program, or engine may be instantiated via logic processor 1102 executing instructions held by non-volatile storage device 1106, using portions of volatile memory 1104. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1108 may be used to present a visual representation of data held by non-volatile storage device 1106. The visual representation may take the form of a graphical user interface (GUI). As the herein described methods and processes change the data held by the non-volatile storage device, and thus transform the state of the non-volatile storage device, the state of display subsystem 1108 may likewise be transformed to visually represent changes in the underlying data. Display subsystem 1108 may include one or more display devices utilizing virtually any type of technology. Such display devices may be combined with logic processor 1102, volatile memory 1104, and/or non-volatile storage device 1106 in a shared enclosure, or such display devices may be peripheral display devices.

When included, input subsystem 1110 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1112 may be configured to communicatively couple various computing devices described herein with each other, and with other devices. Communication subsystem 1112 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 1100 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

Further, the disclosure comprises configurations according to the following clauses.

Clause 1. A method for detecting defects in an additively manufactured object, the method comprising: receiving in-situ spectral data measured from the additively manufactured object during an additive manufacturing process; constructing a graph data structure using the in-situ spectral data; and outputting a predicted defect region using the graph data structure and a trained graph-learning neural network.

Clause 2. The method of clause 1, wherein the trained graph-learning neural network was generated by: initializing a graph-learning neural network; and training the graph-learning neural network using an iterative process comprising: receiving training spectral data measured from a training additively-manufactured object; constructing a training graph data structure using the training spectral data; predicting at least one training defect region using the training graph data structure; computing a loss value by comparing the at least one training defect region with a labeled data set; calculating a gradient with back-propagation using the computed loss value; and updating the graph-learning neural network using the calculated gradient.

Clause 3. The method of clause 2, wherein the training spectral data is down-sampled to remove a portion of data samples corresponding to solid nodes.

Clause 4. The method of clauses 2, wherein the labeled data set is generated by labeling spectral data measured from the training additively-manufactured object using x-ray images of the training additively-manufactured object.

Clause 5. The method of clauses 1 to 4, wherein the in-situ spectral data comprises geo-position information.

Clause 6. The method of clauses 1 to 5, wherein the in-situ spectral data comprises in-situ measurements of infrared light radiating from the additively-manufactured object during the additive manufacturing process.

Clause 7. The method of clauses 1 to 6, wherein constructing the graph data structure comprises: partitioning the in-situ spectral data into a plurality of clusters; and constructing a graph for each cluster in the plurality of clusters.

Clause 8. The method of clause 7, wherein the in-situ spectral data is partitioned into the plurality of clusters using a k-means clustering algorithm.

Clause 9. The method of clause 7, wherein constructing the graph for each cluster comprises defining edge-connections using a K-nearest neighbor graph method.

Clause 10. The method of clauses 1 to 9, wherein the graph data structure comprises a plurality of nodes, wherein each node in the plurality of nodes is classified as one of a solid node or a void node based on a spectral value associated with the respective node.

Clause 11. An additive manufacturing system comprising: an additive manufacturing fabrication system for performing an additive manufacturing process to fabricate an object; a data recording system for recording in-situ spectral data from the object during the additive manufacturing process; a defect detection system configured to: receive the in-situ spectral data from the data recording system; construct a graph data structure using the in-situ spectral data; and output a predicted defect region using the graph data structure and a trained graph-learning neural network; and a process control system configured to adjust the additive manufacturing process based on the predicted defect region.

Clause 12. The additive manufacturing system of clause 11, wherein the trained graph-learning neural network was generated by: initializing a graph-learning neural network; and training the graph-learning neural network using an iterative process comprising: receiving training spectral data measured from a training additively-manufactured object; constructing a training graph data structure using the training spectral data; predicting at least one training defect region using the training graph data structure; computing a loss value by comparing the at least one training defect region with a labeled data set; calculating a gradient with back-propagation using the computed loss value; and updating the graph-learning neural network using the calculated gradient.

Clause 13. The additive manufacturing system of clause 11 or clause 12, wherein the in-situ spectral data comprises geo-position information.

Clause 14. The additive manufacturing system of clauses 11 to 13, wherein constructing the graph data structure comprises: partitioning the in-situ spectral data into a plurality of clusters; and constructing a graph for each cluster in the plurality of clusters.

Clause 15. The additive manufacturing system of clauses 11 to 14, wherein the graph data structure comprises a plurality of nodes, wherein each node in the plurality of nodes is classified as one of a solid node or a void node based on a spectral value associated with the respective node.

Clause 16. A method for constructing graph data for detecting defects in an additively manufactured object, the method comprising: receiving a plurality of spectral data samples, wherein the plurality of spectral data samples is measured in-situ from the additively manufactured object during an additive manufacturing process, and wherein each spectral data sample in the plurality of spectral data samples comprises geo-position information; partitioning the plurality of spectral data samples into a plurality of clusters based on the geo-position information of the plurality of spectral data samples; and constructing a graph for each cluster in the plurality of clusters based on the geo-position information of the plurality of spectral data samples.

Clause 17. The method of clause 16, wherein: each graph comprises a plurality of nodes and a plurality of edges; and each node corresponds to a spectral data sample in the plurality of spectral data samples and comprises a value representing a spectral value associated with the respective spectral data sample.

Clause 18. The method of clause 16 or clause 17, wherein the plurality of spectral data samples is partitioned into the plurality of clusters using a k-means clustering algorithm.

Clause 19. The method of clauses 16 to 18, wherein constructing the graph for each cluster comprises defining edge-connections using a K-nearest neighbor graph method.

Clause 20. The method of clauses 16 to 19, wherein each node in the plurality of nodes is classified as one of a solid node or a void node based on the value associated with the respective node.

1. A method for detecting defects in an additively manufactured object, the method comprising:
receiving in-situ spectral data measured from the additively manufactured object during an additive manufacturing process;
constructing a graph data structure using the in-situ spectral data; and
outputting a predicted defect region using the graph data structure and a trained graph-learning neural network.

2. The method of claim 1, wherein the trained graph-learning neural network was generated by:
initializing a graph-learning neural network; and
training the graph-learning neural network using an iterative process comprising:
receiving training spectral data measured from a training additively-manufactured object;
constructing a training graph data structure using the training spectral data;
predicting at least one training defect region using the training graph data structure;
computing a loss value by comparing the at least one training defect region with a labeled data set;
calculating a gradient with back-propagation using the computed loss value; and
updating the graph-learning neural network using the calculated gradient.

3. The method of claim 2, wherein the training spectral data is down-sampled to remove a portion of data samples corresponding to solid nodes.

4. The method of claim 2, wherein the labeled data set is generated by labeling spectral data measured from the training additively-manufactured object using x-ray images of the training additively-manufactured object.

5. The method of claim 1, wherein the in-situ spectral data comprises geo-position information.

6. The method of claim 1, wherein the in-situ spectral data comprises in-situ measurements of infrared light radiating from the additively-manufactured object during the additive manufacturing process.

7. The method of claim 1, wherein constructing the graph data structure comprises:
partitioning the in-situ spectral data into a plurality of clusters; and
constructing a graph for each cluster in the plurality of clusters.

8. The method of claim 7, wherein the in-situ spectral data is partitioned into the plurality of clusters using a k-means clustering algorithm.

9. The method of claim 7, wherein constructing the graph for each cluster comprises defining edge-connections using a K-nearest neighbor graph method.

10. The method of claim 1, wherein the graph data structure comprises a plurality of nodes, wherein each node in the plurality of nodes is classified as one of a solid node or a void node based on a spectral value associated with the respective node.

11. An additive manufacturing system comprising:
an additive manufacturing fabrication system for performing an additive manufacturing process to fabricate an object;
a data recording system for recording in-situ spectral data from the object during the additive manufacturing process;
a defect detection system configured to:
receive the in-situ spectral data from the data recording system;
construct a graph data structure using the in-situ spectral data; and
output a predicted defect region using the graph data structure and a trained graph-learning neural network; and
a process control system configured to adjust the additive manufacturing process based on the predicted defect region.

12. The additive manufacturing system of claim 11, wherein the trained graph-learning neural network was generated by:
initializing a graph-learning neural network; and
training the graph-learning neural network using an iterative process comprising:
receiving training spectral data measured from a training additively-manufactured object;
constructing a training graph data structure using the training spectral data;
predicting at least one training defect region using the training graph data structure;
computing a loss value by comparing the at least one training defect region with a labeled data set;
calculating a gradient with back-propagation using the computed loss value; and
updating the graph-learning neural network using the calculated gradient.

13. The additive manufacturing system of claim 11, wherein the in-situ spectral data comprises geo-position information.

14. The additive manufacturing system of claim 11, wherein constructing the graph data structure comprises:
partitioning the in-situ spectral data into a plurality of clusters; and
constructing a graph for each cluster in the plurality of clusters.

15. The additive manufacturing system of claim 11, wherein the graph data structure comprises a plurality of nodes, wherein each node in the plurality of nodes is classified as one of a solid node or a void node based on a spectral value associated with the respective node.

16. A method for constructing graph data for detecting defects in an additively manufactured object, the method comprising:
receiving a plurality of spectral data samples, wherein the plurality of spectral data samples is measured in-situ from the additively manufactured object during an additive manufacturing process, and wherein each spectral data sample in the plurality of spectral data samples comprises geo-position information;
partitioning the plurality of spectral data samples into a plurality of clusters based on the geo-position information of the plurality of spectral data samples; and
constructing a graph for each cluster in the plurality of clusters based on the geo-position information of the plurality of spectral data samples.

17. The method of claim 16, wherein:
each graph comprises a plurality of nodes and a plurality of edges; and
each node corresponds to a spectral data sample in the plurality of spectral data samples and comprises a value representing a spectral value associated with the respective spectral data sample.

18. The method of claim 16, wherein the plurality of spectral data samples is partitioned into the plurality of clusters using a k-means clustering algorithm.

19. The method of claim 16, wherein constructing the graph for each cluster comprises defining edge-connections using a K-nearest neighbor graph method.

20. The method of claim 16, wherein each node in the plurality of nodes is classified as one of a solid node or a void node based on the value associated with the respective node.
